(19) United States
(12) Patent Application Publication
(10) Pub. No.: US 2014/0314243 A1
(43) Pub. Date: Oct. 23, 2014

(54) CLICK AND POP NOISE REDUCTION IN HEADPHONES

(71) Applicant: QUALCOMM Incorporated, San Diego, CA (US)

(72) Inventor: Arash Mehrabi, San Diego, CA (US)

(73) Assignee: QUALCOMM Incorporated, San Diego, CA (US)

(21) Appl. No.: 13/900,141

(22) Filed: May 22, 2013

Related U.S. Application Data
(60) Provisional application No. 61/813,572, filed on Apr. 18, 2013.

(51) Int. Cl. H04R 3/00

(52) U.S. Cl. CPC H04R 3/002
USPC 381/71.6

(57) ABSTRACT

A method and an apparatus are provided. The apparatus reduces noise in headphones due to a change in a current or a voltage in headphones while determining an impedance of the headphones. The apparatus generates a digital waveform that reduces noise in the headphones when applied for an impedance determination. The apparatus converts the digital waveform to an analog waveform. The apparatus applies the analog waveform to an input of the headphones while reducing the noise in the headphones due to the application of the analog waveform for the impedance determination. The apparatus determines the impedance of the headphones based on the applied analog waveform. A first derivative of the analog waveform may be continuous. In particular, the analog waveform may be “s” shaped. The digital waveform may be generated based on a ramp digital waveform. The ramp digital waveform may be generated based on a step digital waveform.

### CROSS-REFERENCE TO RELATED APPLICATION(S)

This application claims the benefit of U.S. Provisional Application Ser. No. 61/813,572, entitled “Click and Pop Noise Reduction in Headphones” and filed on Apr. 18, 2013, which is expressly incorporated by reference herein in its entirety.

### BACKGROUND

1. Field

The present disclosure relates generally to communication systems, and more particularly, to reducing click and pop noise in headphones when determining an impedance of the headphones.

2. Background

Headphones are a pair of speakers that are designed to be placed close to a user's ears. Headphones may be referred to as earspeakers, earphones, earbuds, or the like. When combined with a microphone, the headphones may be referred to as a headset. Headphones are available with varied impedances. Headphones with a low impedance typically have an impedance in the range of 16-32 ohms, and headphones with a high impedance typically have an impedance in the range of 100-600 ohms. As the impedance of headphones decreases, less voltage but more current is required to drive the headphones. Accordingly, a headphone source (e.g., an amplifier) to which the headphones are connected may need to determine the impedance of the headphones so that a proper drive current or drive voltage may be applied to obtain the requisite power in order to achieve the requisite volume.

When determining the impedance of headphones, a drive current or a drive voltage must be applied. When changing the drive current or the drive voltage, the headphones may produce a click or a pop noise that is undesirable for a user. Headphones that produce less of a click and pop noise may be more desirable for a user. Accordingly, there is an existing need for reducing the click and pop noise in headphones while determining an impedance of the headphones.

### SUMMARY

In an aspect of the disclosure, a method and an apparatus are provided. The apparatus reduces noise in headphones due to a change in a current or a voltage in headphones while determining an impedance of the headphones. The apparatus generates a digital waveform that reduces noise in the headphones when applied for an impedance determination. The apparatus converts the digital waveform to an analog waveform. The apparatus applies the analog waveform to an input of the headphones while reducing the noise in the headphones due to the application of the analog waveform for the impedance determination. The apparatus determines the impedance of the headphones based on the applied analog waveform. A first derivative of the analog waveform may be continuous. In particular, the analog waveform may be “s” shaped. The digital waveform may be generated based on a ramp digital waveform. The ramp digital waveform may be generated based on a step digital waveform.

### BRIEF DESCRIPTION OF THE DRAWINGS

FIG. 1 is a first diagram illustrating an exemplary impedance determination apparatus.

FIG. 2 is a second diagram illustrating an exemplary impedance determination apparatus.

FIG. 3 is a diagram illustrating an exemplary digital waveform generator module.

FIG. 4 is a diagram illustrating an exemplary step digital waveform for generating a ramp digital waveform.

FIG. 5 is a diagram illustrating an exemplary ramp digital waveform for generating a digital waveform for impedance determination.

FIG. 6 is a diagram illustrating an exemplary digital waveform for impedance determination.

FIG. 7 is another diagram illustrating an exemplary step digital waveform for generating a ramp digital waveform.

FIG. 8 is another diagram illustrating an exemplary ramp digital waveform for generating a digital waveform for impedance determination.

FIG. 9 is another diagram illustrating an exemplary digital waveform for impedance determination.

FIGS. 10A, 10B, and 10C are diagrams illustrating yet another exemplary step digital waveform for generating a ramp digital waveform, an exemplary ramp digital waveform for generating a digital waveform for impedance determination, and an exemplary digital waveform for impedance determination.

FIG. 11 is a flow chart of a method of reducing noise in headphones due to a change in a current or a voltage in the headphones while determining an impedance of the headphones.

FIG. 12 is a conceptual data flow diagram illustrating the data flow between different modules/means/components in an exemplary apparatus.

FIG. 13 is a diagram illustrating an example of a hardware implementation for an apparatus employing a processing system/controller.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

Headphones are available with impedances that range from around 16 ohms to about 600 ohms. In order to provide adequate power to drive the headphones for producing an adequate volume range, the headphone source may need to determine the impedance of the headphones. When determining the impedance of headphones, a drive current or a drive voltage must be applied. When changing the drive current or the drive voltage, the headphones may produce a click and/or a pop noise that is undesirable for a user. Methods and apparatuses that reduce the click and/or pop noise when determining (or detecting) an impedance of the headphones is provided infra.

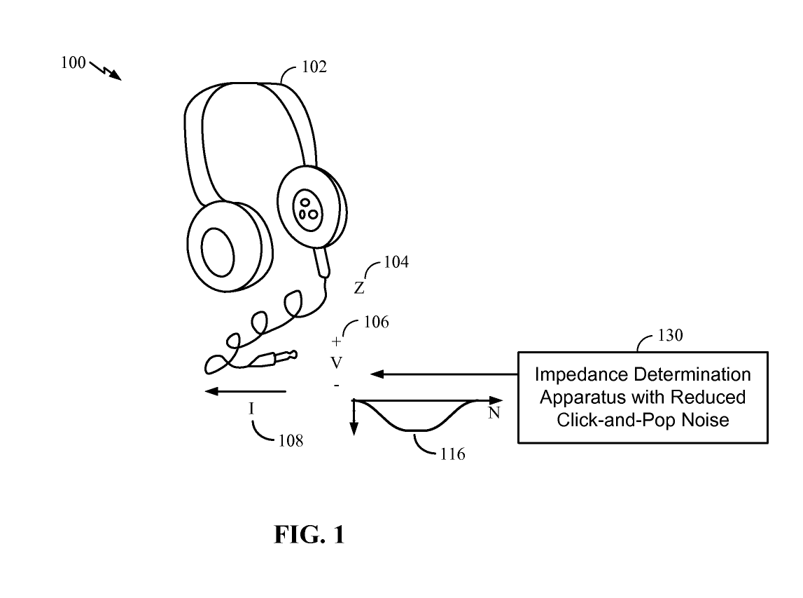

FIG. 1 is a first diagram 100 illustrating an exemplary impedance determination apparatus 130. As shown in FIG. 1, a pair of headphones 102 has an impedance Z 104. The impedance determination apparatus 130 applies a drive voltage 106 or a drive current 108 in order to determine the impedance Z 104. The change in the drive voltage 106 and/or the drive current 108 causes a click and/or a pop noise in the pair of headphones 102. The impedance determination apparatus 130 applies the drive voltage 106 or the drive current 108 with a particular waveform/shape 116 in order to reduce the click and pop noise from the pair of headphones 102 while determining the impedance Z 104 of the pair of headphones 102.

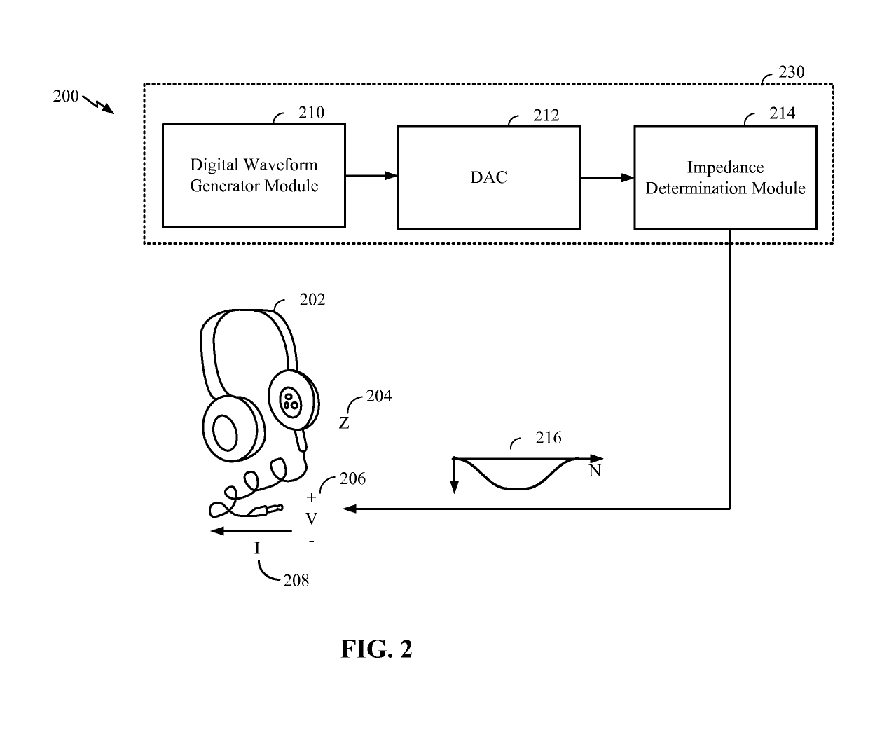

FIG. 2 is a second diagram 200 illustrating an exemplary impedance determination apparatus 230. The impedance determination apparatus 230 corresponds to the impedance determination apparatus 130 of FIG. 1. The impedance determination apparatus 230 includes a digital waveform generator module 210 for generating a digital waveform, a digital to analog converter (DAC) 212 for converting the digital waveform to an analog waveform 216, and an impedance determination module 214. The impedance determination module 214 applies the analog waveform 216 to the input of the headphones 202, and determines an impedance Z 204 of the headphones 202 based on the applied analog waveform 216. The applied analog waveform 216 is a drive voltage 206 or a drive current 208. When the applied analog waveform 216 is a drive voltage V 206, the impedance determination module 214 determines the current 1208 due to the drive voltage V 206, and determines the impedance Z 204 as V. When the applied analog waveform 216 is a drive current I 208, the impedance determination module 214 determines the voltage V 206 due to the drive current 1208, and determines the impedance Z 204 as V.

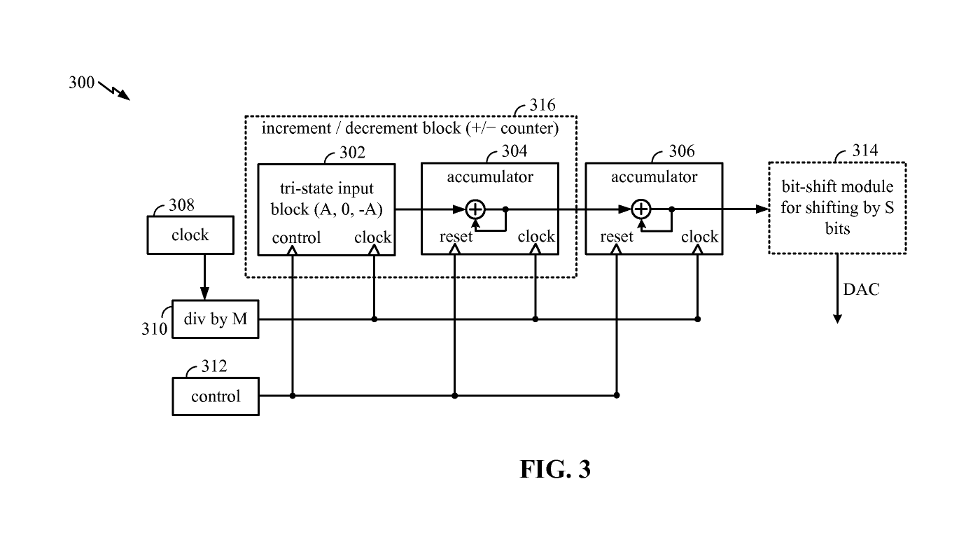

FIG. 3 is a diagram illustrating an exemplary digital waveform generator module 300. The digital waveform generator module 300 corresponds to the digital waveform generator module 210 of FIG. 2. The digital waveform generator module 300 may include a tri-state input block 302 for providing one of three states A, 0, and −A to an accumulator 304 (e.g., a resettable integrator), where A is an integer and |A|≧1 (e.g., A=1 or A=−1). The accumulator 304 integrates the input from the tri-state input block 302. The accumulator 304 outputs the integrated input from the tri-state input block 302 to an accumulator 306 (e.g., a resettable integrator). The accumulator 306 integrates the output from the accumulator 304. The accumulator 306 provides the integrated output to a DAC or to a bit-shift module 314. The digital waveform generator module 300 may further include the bit-shift module 314, which is configured to shift the output from the accumulator 306 by S bits in order to increase or to decrease a magnitude of the digital signal received from the accumulator 306. The bit-shift module 314 shifts the bits of the digital signal received from the accumulator 306 to the left to multiply the magnitude of the digital signal provided to the DAC by 2^{S} and to the right to divide the magnitude of the digital signal provided to the DAC by 2^{S}. The tri-state input block 302 and the accumulator 304 may be replaced by an increment/decrement block (i.e., a plus/minus counter) 316. The tri-state input block 302, the accumulator 304, the increment/decrement block 316, and the accumulator 306 are controlled by control logic 312. The tri-state input block 302, the accumulator 304, the increment/decrement block 316, and the accumulator 306 are coupled to a clock 308. The clock frequency f_{clock} of the clock 308 may be divided down by M by the divider 310. As such, the effective clock frequency may be f_{clock}/M. The effective clock period is T_{c}, where T_{c}=M/f_{clock}.

In a first configuration, to create the digital waveform provided to the DAC, the accumulators 304, 306 are reset to zero. The tri-state input block 302 then outputs state A T_{R1} times, state 0 T_{Z1} times, and state −A T_{R2} times. The tri-state input block 302 then outputs state 0 T_{H} times. Subsequently, the tri-state input block 302 outputs state −A T_{R3} times, state 0 T_{Z2} times, and state A T_{R4} times. The values T_{R1}, T_{R2}, T_{R3}, T_{R4}, T_{Z1}, T_{Z2}, and T_{H} are integers; and T_{R1}≧1, T_{R2}≧1, T_{R3}≧1, T_{R4}>1, T_{Z1}≧0, T_{Z2}≧0, and T_{S}≧0. In one configuration, T_{R1}+T_{R2}=T_{R3}+T_{R4}. In another configuration, T_{R1}, T_{R2}, T_{R3}, and T_{R4} are equal to T_{R}, and T_{Z1} and T_{Z2} are equal to T_{S}. The accumulator 304 integrates the input received from the tri-state input block 302 to produce a ramp digital waveform. The accumulator 306 integrates the ramp digital waveform received from the accumulator 304 to produce a second order polynomial waveform. The second order polynomial waveform may then be provided to the bit-shift module 314 and then to the DAC, or may be provided directly to the DAC.

In a second configuration, to create the digital waveform provided to the DAC, the increment/decrement block 316 and the accumulator 306 are reset to zero. The increment/decrement block 316 then increments/decrements to produce the ramp digital waveform for the accumulator 306. In a first sub-configuration, where A is an integer and A≧1, the increment/decrement block 316 increments T_{R1} times by A, holds the state T_{Z1} times, decrements T_{R2} times by A, holds the state T_{H} times, decrements T_{R3} times by A, holds the state T_{Z2} times, and increments T_{R4} times by A. In a second sub-configuration, where A is an integer and A≧1, the increment/decrement block 316 decrements T_{R1} times by A, holds the state T_{Z1} times, increments T_{R2} times by A, holds the state T_{H} times, increments T_{R3} times by A, holds the state T_{Z2} times, and decrements T_{R4} times by A. The values T_{R1}, T_{R2}, T_{R3}, T_{R4}, T_{Z1}, T_{Z2}, and T_{H} are integers; and T_{R1}≧1, T_{R2}≧1, T_{R3}≧1, T_{R4}≧1, T_{Z1}≧0, T_{Z2}≧0, and T_{S}≧0. In one configuration, T_{R1}+T_{R2}=T_{R3}+T_{R4}. In another configuration, T_{R1}, T_{R2}, T_{R3}, and T_{R4} are equal to T_{R}, and T_{Z1} and T_{Z2} are equal to T_{Z}. The accumulator 306 integrates the ramp digital waveform received from the increment/decrement block 316 to produce a second order polynomial waveform. The second order polynomial waveform may then be provided to the bit-shift module 314 and then to the DAC, or may be provided directly to the DAC. In the second configuration, if A is an integer and A≦1, incrementing by A is effectively decrementing by −A and decrementing by A is effectively incrementing by −A.

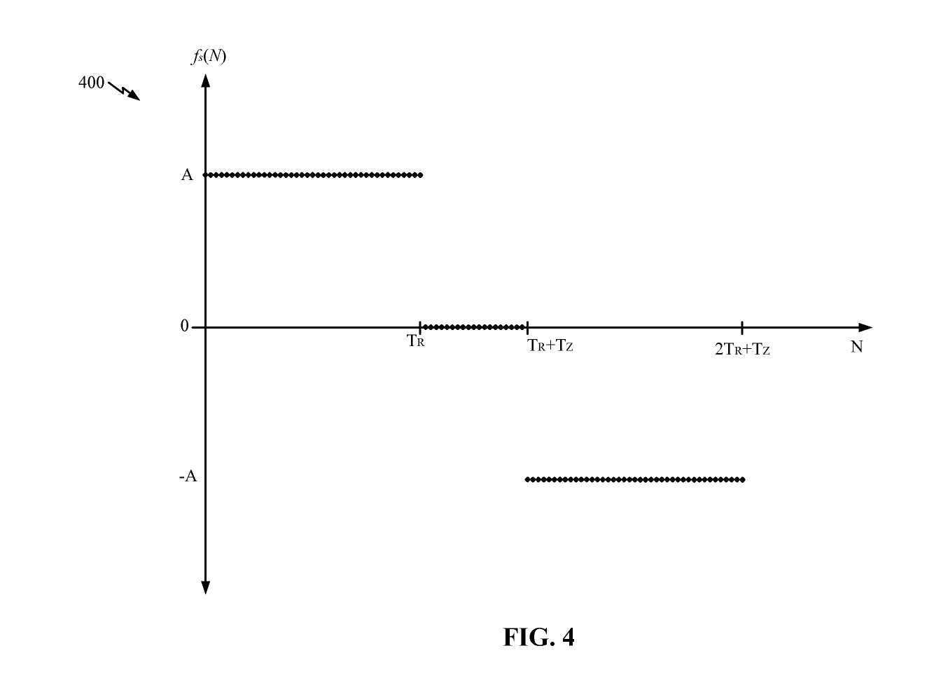

FIG. 4 is a diagram illustrating an exemplary step digital waveform f_{S}(N) 400 for generating a ramp digital waveform. As discussed supra, the tri-state input block 302 may output state A T_{R1} times, state 0 T_{Z1} times, state −A T_{R2} times, state 0 T_{H} times, state −A T_{R3} times, state 0 T_{Z2} times, and state A T_{R4} times. For simplicity, T_{R1}, T_{R2}, T_{R3}, and T_{R4} are assumed to equal T_{R}, and T_{Z1} and T_{Z2} are assumed to equal T_{Z}. As shown in FIG. 4, to obtain the drive voltage or drive current for determining the impedance of the headphones, the tri-state input block 302 may output state A T_{R} times, state 0 T_{Z} times, and state −A T_{R} times. The drive voltage or drive current is obtained after 2T_{R}+T_{Z} clock cycles, plus some added delay as the signal propagates through the processing blocks to the DAC and to the impedance determination module. Assuming a clock cycle has a period of T_{c}, the drive voltage or drive current is obtained in a time period approximately equal to (2T_{R}+T_{Z})T_{c} plus the added processing delay. The step digital waveform f_{S}(N) is equal to A for 0≦N≦T_{R}, 0 for T_{R}<N<T_{R}+T_{Z}, and −A for T_{R}+T_{Z}≦N≦2T_{R}+T_{Z}, where the N (clock cycle), T_{R}, and T_{Z} are integers, T_{R}>0, and T_{Z}≧0. After obtaining the drive voltage or the drive current for determining the impedance of the headphones, the tri-state input block 302 may hold the state T_{H} times. The tri-state input block 302 may then change the drive voltage or drive current back to an initial state by reversing the process and outputting the state −A T_{R} times, the state 0 T_{Z} times, and the state A T_{R} times.

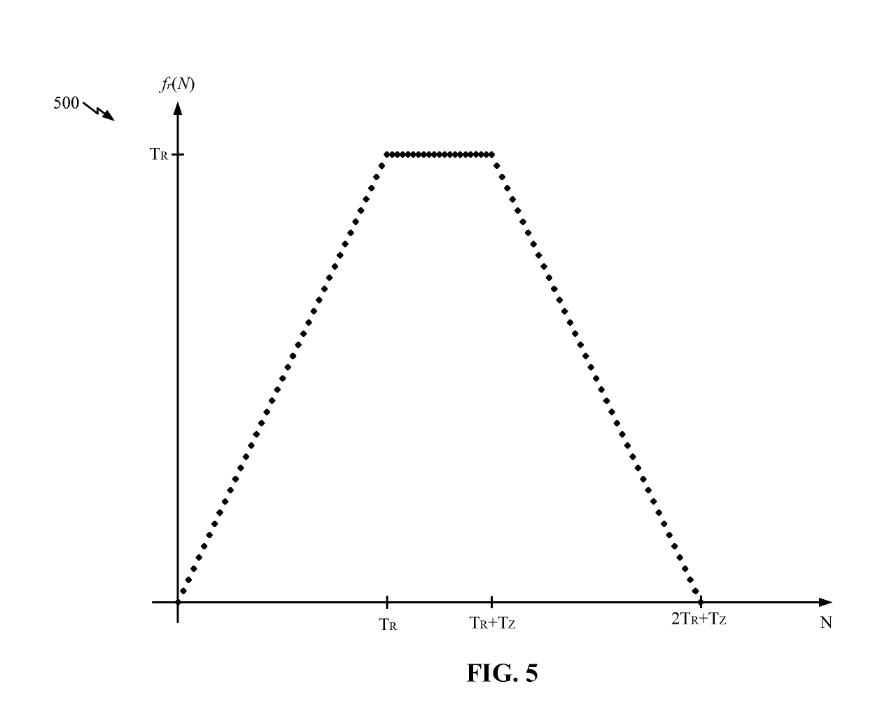

FIG. 5 is a diagram illustrating an exemplary ramp digital waveform fᵣ(N) 500 for generating a digital waveform for impedance determination. As discussed supra, the accumulator 304 may integrate the step digital waveform 400 input from the tri-state input block 302 to obtain the ramp digital waveform 500. Alternatively, an increment/decrement block 316 may generate the ramp digital waveform 500 by incrementing T_{R} times by A, holding the state T_{Z} times, and decrementing T_{R} times by A. In FIG. 5, only the portion of the digital waveform for obtaining the drive voltage or drive current is illustrated. The ramp digital waveform fᵣ(N) is equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N (clock cycle), T_{R}, and T_{Z} are integers, T_{R}>0, and T_{Z}≧0.

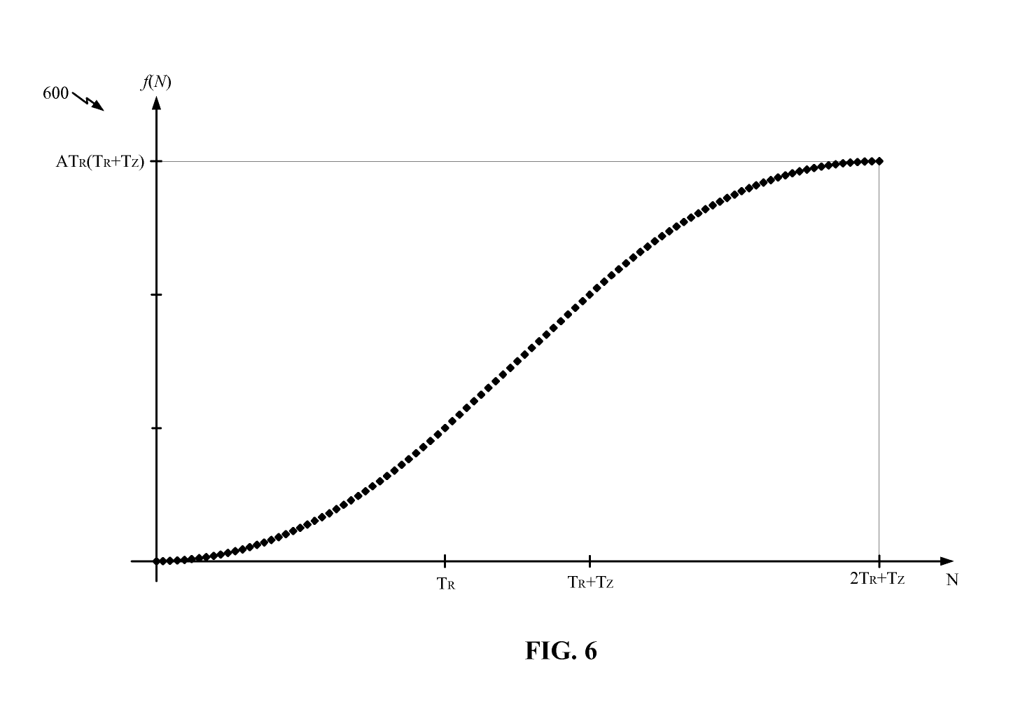

FIG. 6 is a diagram illustrating an exemplary digital waveform f(N) 600 for impedance determination. As discussed supra, the accumulator 306 integrates the ramp digital waveform fᵣ(N) 500 output from the accumulator 304 or the increment/decrement block 316. The accumulator 306 outputs the digital waveform f(N). The digital waveform f(N) is a second order polynomial and has an “s” shape. The first derivative of the digital waveform f(N) is continuous. Having an “s” shaped digital waveform f(N) 600, where f′(N) is continuous, reduces the click and/or pop noise that occurs when a voltage or a current is applied based on the digital waveform f(N) 600. The digital waveform f(N) may be equal to AN²/2 for 0≦N≦T_{R}, AT_{R}N−AT_{R}²/2 for T_{R}<N<T_{R}+T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}≧0. The maximum voltage/current outputted from the accumulator 306 is AT_{R}(T_{R}+T_{Z}).

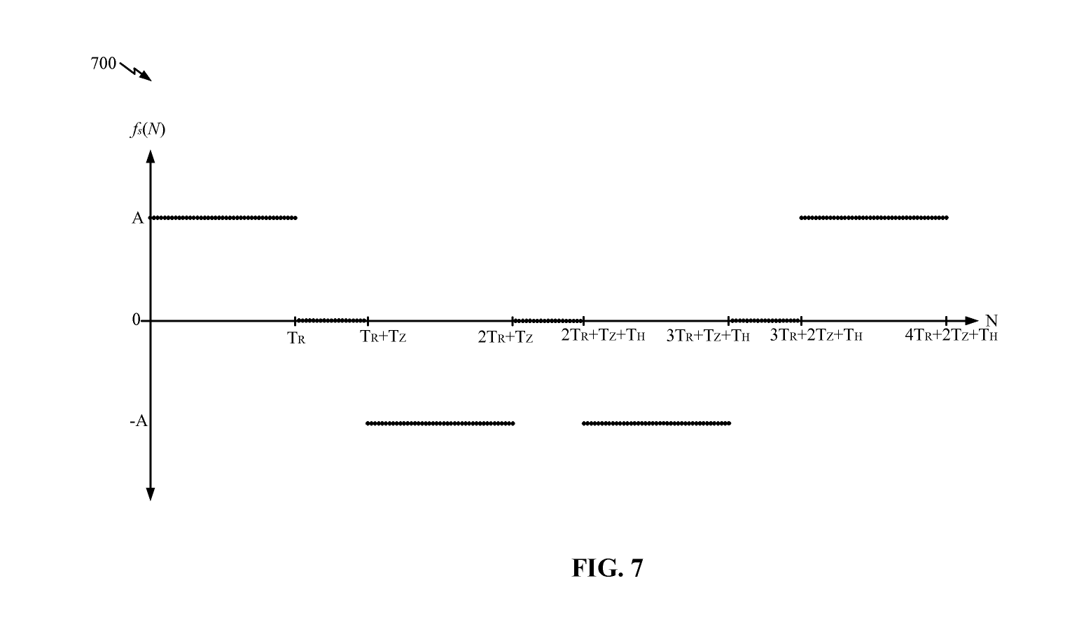

FIG. 7 is another diagram illustrating an exemplary step digital waveform 700 for generating a ramp digital waveform. The tri-state input block 302 may output state A T_{R1} times, state 0 T_{Z1} times, state −A T_{R2} times, state 0 T_{H} times, state −A T_{R3} times, state 0 T_{Z2} times, and state A T_{R4} times. For simplicity in FIG. 7, T_{R1}, T_{R2}, T_{R3}, and T_{R4} are assumed to equal T_{R}, and T_{Z1} and T_{Z2} are assumed to equal T_{Z}. Accordingly, to obtain a drive voltage or current for determining an impedance of headphones, the tri-state input block 302 may output state A T_{R} times, state 0 T_{Z} times, and state −A T_{R} times. The tri-state input block 302 may then output a hold state of 0 T_{H} times. The portion of the analog signal that corresponds to the hold state of 0 T_{H} may be when the impedance determination module 214 determines the impedance of headphones. The tri-state input block 302 may then reverse the process and output state −A T_{R} times, state 0 T_{Z} times, and state A T_{R} times in order to change the drive voltage or the drive current back to an initial state.

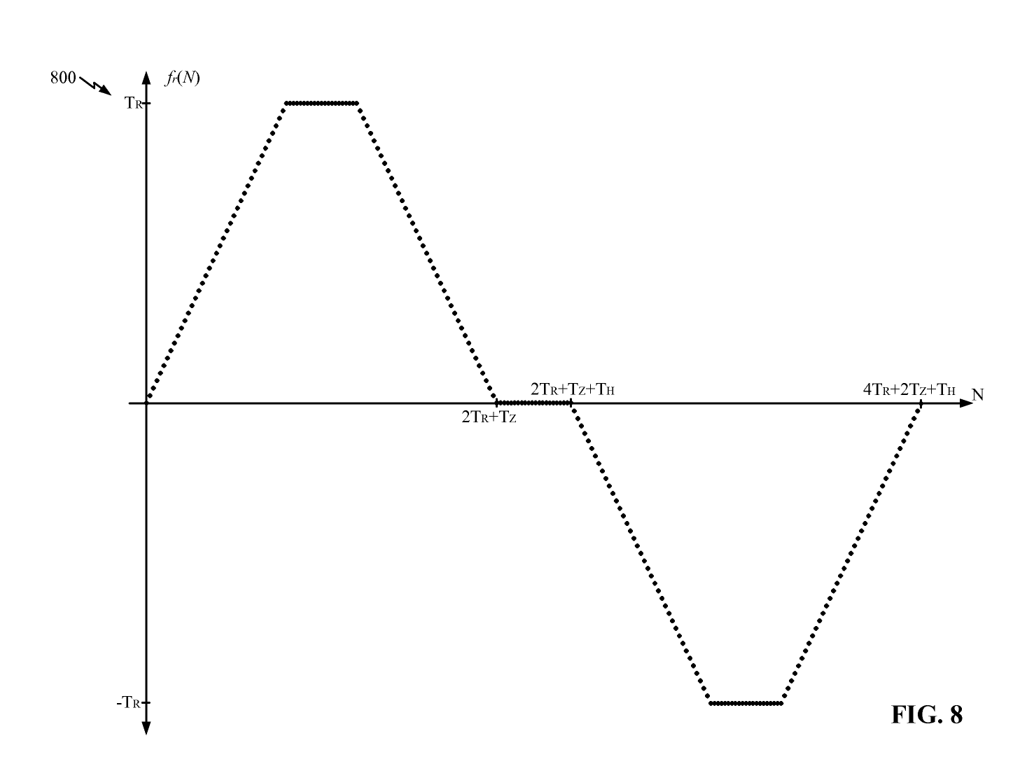

FIG. 8 is another diagram illustrating an exemplary ramp digital waveform 800 for generating a digital waveform for impedance determination. The accumulator 304 may integrate the step digital waveform 700 output from the tri-state input block 302 to produce the ramp digital waveform 800. Alternatively, the increment/decrement block 316 may increment T_{R1} times by A, hold the state T_{Z1} times, decrement T_{R2} times by A, hold the state T_{H} times, decrement T_{R3} times by A, hold the state T_{Z2} times, and increment T_{R4} times by A. For simplicity in FIG. 8, T_{R1}, T_{R2}, T_{R3}, and T_{R4} are assumed to equal T_{R}, and T_{Z1} and T_{Z2} are assumed to equal T_{Z}. Accordingly, to obtain a drive voltage or current for determining an impedance of headphones, the increment/decrement block 306 may increment T_{R} times by A, hold the state T_{Z} times, and decrement T_{R} times by A. The increment/decrement block 306 may then hold the state T_{H} times. The portion of the analog signal that corresponds to the hold state T_{H} times may be when the impedance determination module 214 determines the impedance of the headphones. The increment/decrement block 306 may then reverse the process and decrement T_{R} times by A, hold the state T_{Z} times, and increment T_{R} times by A in order to change the drive voltage or the drive current back to an initial state.

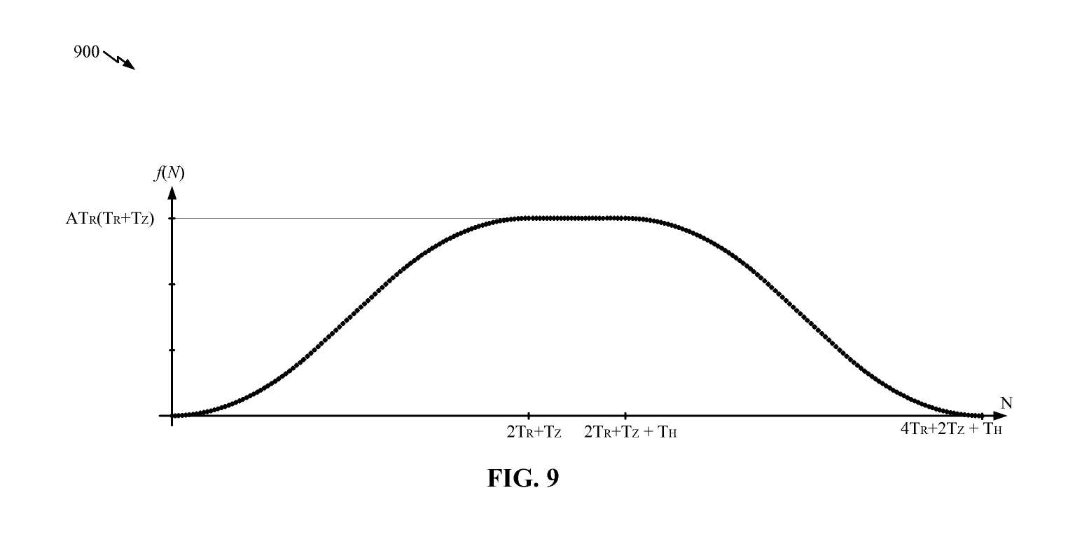

FIG. 9 is another diagram illustrating an exemplary digital waveform 900 for impedance determination. The accumulator 306 may integrate the ramp digital waveform 800 output from the accumulator 304 or the increment/decrement block 316 to produce the digital waveform 900. The digital waveform 900 peaks at a voltage or a current of AT_{R}(T_{R}+T_{Z}) after 2T_{R}+T_{Z} clock cycles. The impedance determination module 214 may determine the impedance during a portion of the analog waveform that corresponds to the portion of the digital waveform 900 between 2T_{R}+T_{Z} clock cycles and 2T_{R}+T_{Z}+T_{H} clock cycles.

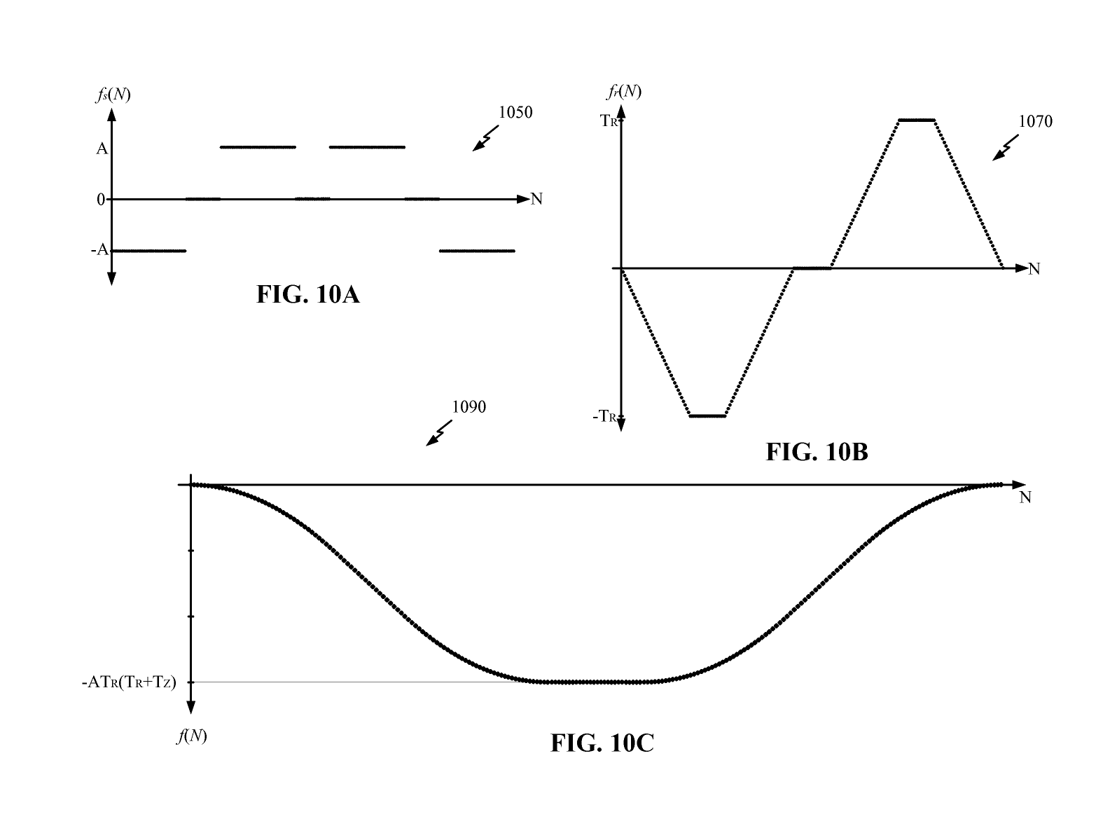

FIGS. 10A, 10B, and 10C are diagrams illustrating yet another exemplary step digital waveform 1050 for generating a ramp digital waveform 1060, an exemplary ramp digital waveform 1070 for generating a digital waveform 1090 for impedance determination, and an exemplary digital waveform 1090 for impedance determination. The waveforms illustrated in FIGS. 7, 8, 9 may be inverted as shown in FIGS. 10A, 10B, 10C.

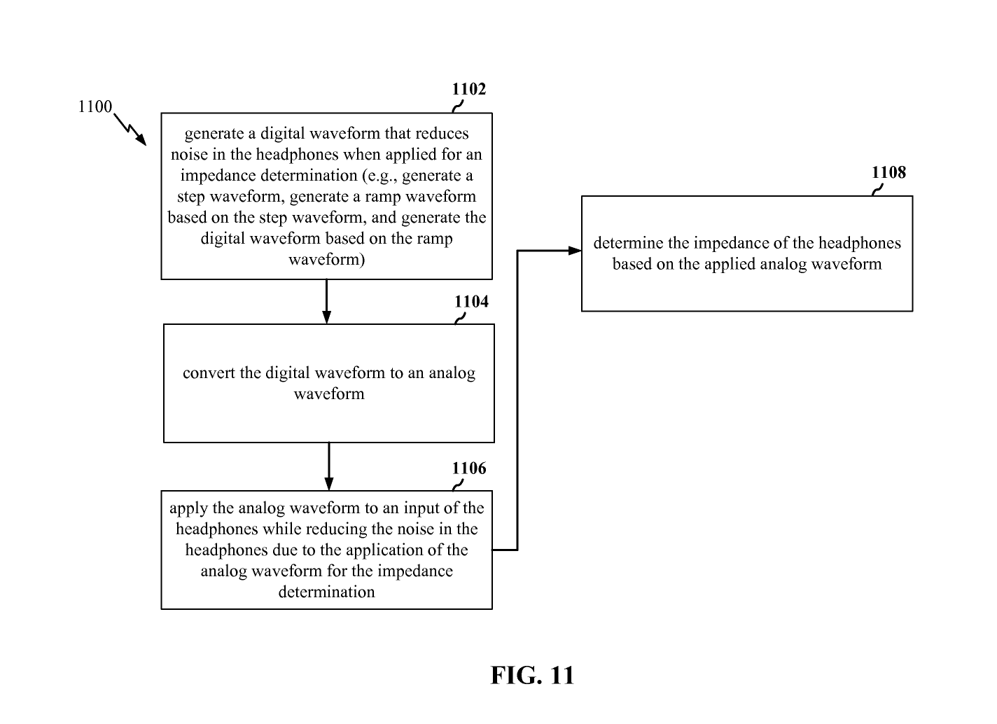

FIG. 11 is a flow chart 1100 of a method of reducing noise in headphones due to a change in a current or a voltage in the headphones while determining an impedance of the headphones. The method may be performed by an impedance determination apparatus, such as the impedance determination apparatus 130, 230. The apparatus reduces noise in headphones due to a change in a current or a voltage in the headphones while determining an impedance of the headphones. In step 1102, the apparatus generates a digital waveform that reduces noise in the headphones when applied for an impedance determination. For example, the apparatus may generate the digital waveform illustrated in FIG. 6, 9, or 10C. In step 1104, the apparatus converts the digital waveform to an analog waveform. For example, the apparatus may convert the digital waveform illustrated in FIG. 6, 9, or 10C to an analog waveform with a DAC 212. In step 1106, the apparatus may apply the analog waveform to an input of the headphones while reducing the noise in the headphones due to the application of the analog waveform for the impedance determination. In step 1108, the apparatus may determine the impedance of the headphones based on the applied analog waveform. The apparatus determines the impedance of the headphones at a peak of the analog waveform. The apparatus generates the digital waveform and applies the converted analog waveform such that as the current or the voltage approaches a peak, noise in the headphones due to the change in the current or the voltage is reduced or minimized. To reduce or to minimize the noise in the headphones due to the change in the current or the voltage while determining an impedance of the headphones, a first derivative of the analog waveform may be continuous. In particular, the analog waveform may be “s” shaped. For example, the digital waveform illustrated in FIGS. 6, 9, and 10C is “s” shaped. As such, the analog waveform output from the DAC 212 will also be “s” shaped.

In step 1102, the apparatus may generate the digital waveform by generating a ramp digital waveform fᵣ(N). For example, the apparatus may generate the ramp digital waveform fᵣ(N) illustrated in FIG. 5, 8, or 10B. The apparatus may generate the ramp digital waveform fᵣ(N) by integrating, with an accumulator, input from a tri-state input block. For example, the apparatus may generate the ramp digital waveform fᵣ(N) of FIG. 5, 8, or 10B by integrating, with the accumulator 304, input from the tri-state input block 302. The apparatus may generate the ramp digital waveform fᵣ(N) with an increment/decrement block. For example, the apparatus may generate the ramp digital waveform fᵣ(N) of FIG. 5, 8, or 10B with an increment/decrement block 316. An initial portion of the ramp digital waveform fᵣ(N) (for obtaining the drive current or drive voltage) may be equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N, T_{R}, and T_{Z} are integers, T_{R}>0, and T_{Z}≧0. In the aforementioned equation for the ramp digital waveform fᵣ(N), T_{R1}, T_{R2}, T_{R3}, and T_{R4} are assumed to equal T_{R}, and T_{Z1} and T_{Z2} are assumed to equal T_{Z}. However, T_{R1}, T_{R2}, T_{R3}, and T_{R4} may be unequal and T_{Z1} and T_{Z2} may be unequal.

In step 1102, the apparatus may generate the digital waveform by integrating the ramp digital waveform fᵣ(N) to generate the digital waveform. For example, the apparatus may generate the digital waveform of FIG. 6, 9, or 10C by integrating the ramp digital waveform fᵣ(N) of FIG. 5, 8, or 10B. The digital waveform may be generated by integrating, with an accumulator, the ramp digital waveform fᵣ(N). For example, the digital waveform of FIG. 6, 9, or 10C may be generated by integrating, with the accumulator 306, the ramp digital waveform fᵣ(N) of FIG. 5, 8, or 10B.

In step 1102, the apparatus may generate the ramp digital waveform fᵣ(N) by generating a step digital waveform f_{S}(N), and integrating the step digital waveform f_{S}(N) to generate the ramp digital waveform fᵣ(N). For example, the apparatus may generate the ramp digital waveform fᵣ(N) of FIG. 5, 8, or 10B by generating a step digital waveform f_{S}(N) of FIG. 4, 7, or 10A, and integrating the step digital waveform f_{S}(N) of FIG. 4, 7, or 10A to generate the ramp digital waveform fᵣ(N) of FIG. 5, 8, or 10B. The ramp digital waveform fᵣ(N) may be generated by integrating, with an accumulator, the step digital waveform f_{S}(N). For example, the apparatus may generate the ramp digital waveform fᵣ(N) of FIG. 5, 8, or 10B by integrating, with the accumulator 304, the step digital waveform L(N) of FIG. 4, 7, or 10A. An initial portion of the step digital waveform f_{S}(N) (for obtaining the drive current or drive voltage) may be equal to A for 0≦N≦T_{R}, 0 for T_{R}<N<T_{R}+T_{Z}, and −A for T_{R}+T_{Z}≦N≦2T_{R}+T_{Z}, where N, T_{R}, and T_{Z} are integers, T_{R}>0, and T_{Z}>0. In the aforementioned equation for the step digital waveform f_{S}(N), T_{R1}, T_{R2}, T_{R3}, and T_{R4} are assumed to equal T_{R}, and T_{Z1} and T_{Z2} are assumed to equal T_{Z}. However, T_{R1}, T_{R2}, T_{R3}, and T_{R4} may be unequal and T_{Z1} and T_{Z2} may be unequal.

An initial portion of the digital waveform f(N) (for obtaining the drive current or drive voltage) may be equal to AN²/2 for 0≦N≦T_{R}, AT_{R}N−AT_{R}²/2 for T_{R}<N<T_{R}+T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}>0. In the aforementioned equation for the digital waveform f(N), T_{R1}, T_{R2}, T_{R3}, and T_{R4} are assumed to equal T_{R}, and T_{Z1} and T_{Z2} are assumed to equal T_{Z}. However, T_{R1}, T_{R2}, T_{R3}, and T_{R4} may be unequal and T_{Z1} and T_{Z2} may be unequal.

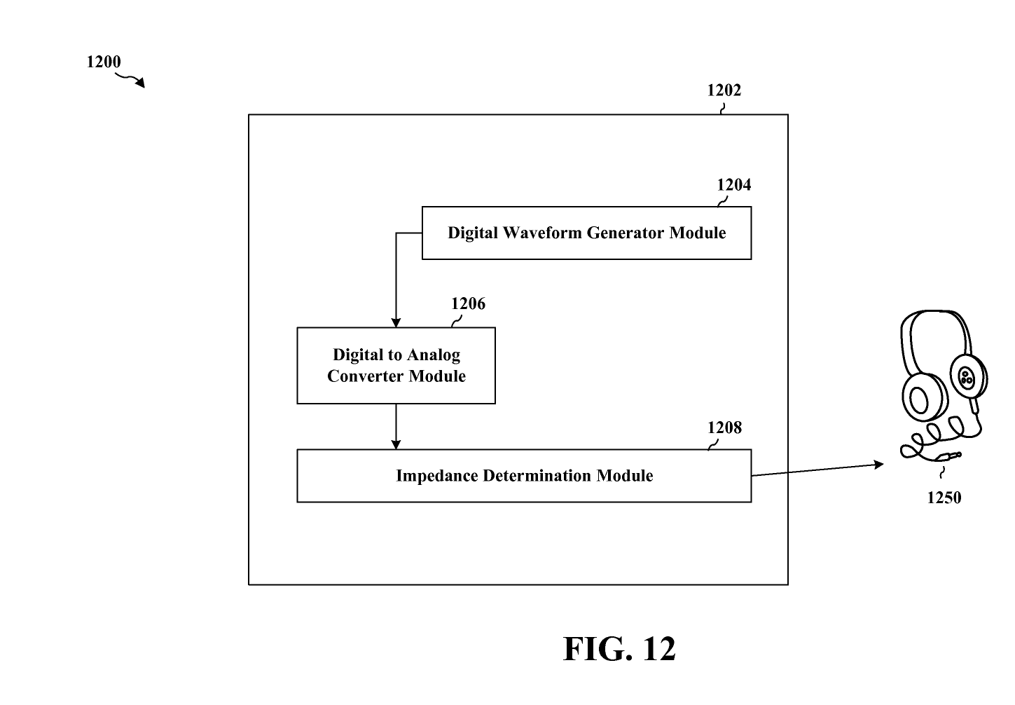

FIG. 12 is a conceptual data flow diagram 1200 illustrating the data flow between different modules/means/components in an exemplary apparatus 1202. The apparatus 1202 may reduce noise in headphones due to a change in a current or a voltage in the headphones while determining an impedance of the headphones. The apparatus 1202 includes a digital waveform generator module 1204 that is configured to generate a digital waveform that reduces noise in the headphones when applied for an impedance determination. The apparatus 1202 further includes a digital to analog converter module 1206 that is configured to convert the digital waveform to an analog waveform. The apparatus 1202 further includes an impedance determination module 1208 that is configured to apply the analog waveform to an input of the headphones while reducing the noise in the headphones due to the application of the analog waveform for the impedance determination, and to determine the impedance of the headphones based on the applied analog waveform. The first derivative of the analog waveform may be continuous. The analog waveform may be “s” shaped. The digital waveform generator module 1204 may generate the digital waveform by generating a ramp digital waveform fᵣ(N). The digital waveform generator module 1204 may generate the ramp digital waveform fᵣ(N) by integrating, with an accumulator, input from a tri-state input block. The digital waveform generator module 1204 may generate the ramp digital waveform fᵣ(N) with an increment/decrement block. The ramp digital waveform fᵣ(N) may be equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N, T_{R}, and T_{Z} are integers, T_{R}>0, and T_{Z}≧0.

The digital waveform generator module 1204 may generate the digital waveform by integrating the ramp digital waveform fᵣ(N) to generate the digital waveform. The digital waveform generator module 1204 may generate the digital waveform by integrating, with an accumulator, the ramp digital waveform fᵣ(N). The digital waveform generator module 1204 may generate the ramp digital waveform fᵣ(N) by generating a step digital waveform f_{S}(N), and integrating the step digital waveform f_{S}(N) to generate the ramp digital waveform fᵣ(N). The digital waveform generator module 1204 may generate the ramp digital waveform fᵣ(N) by integrating, with an accumulator, the step digital waveform f_{S}(N). The step digital waveform f_{S}(N) may be equal to A for 0≦N≦T_{R}, 0 for T_{R}<N<T_{R}+T_{Z}, and −A for T_{R}+T_{Z}≦N≦2T_{R}+T_{Z}, where N, T_{R}, and T_{Z} are integers, T_{R}>0, and T_{Z}≧0. The digital waveform f(N) may be equal to AN²/2 for 0≦N≦T_{R}, AT_{R}N−AT_{R}²/2 for T_{R}<N<T_{R}+T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}≧0.

The apparatus may include additional modules that perform each of the steps of the algorithm in the aforementioned flow chart of FIG. 11. As such, each step in the aforementioned flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

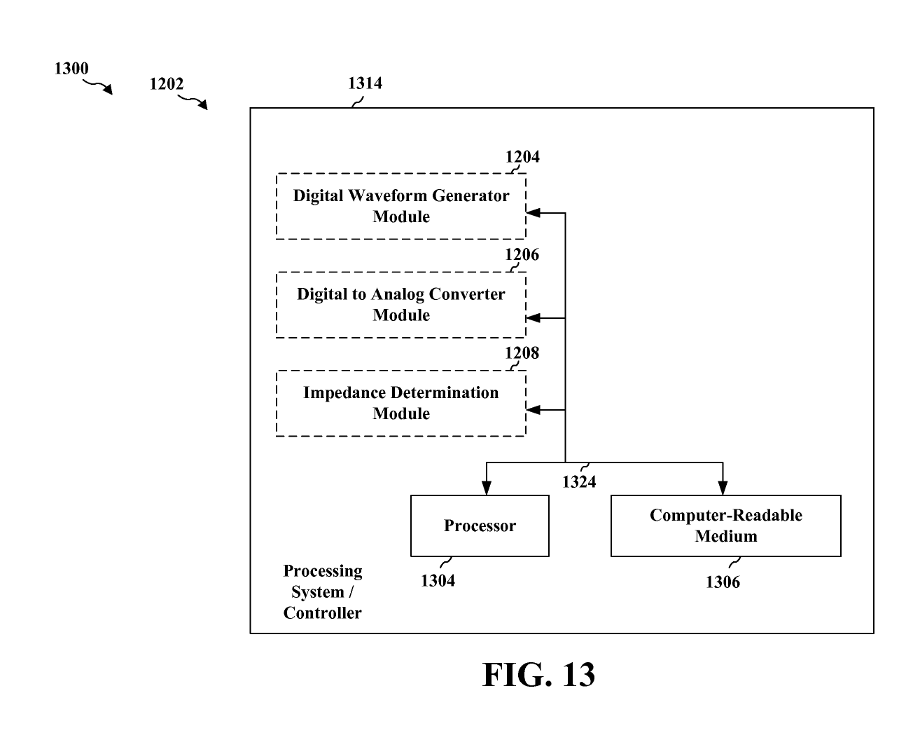

FIG. 13 is a diagram illustrating an example of a hardware implementation for an apparatus employing a processing system/controller. The processing system/controller 1314 may be implemented with a bus architecture, represented generally by the bus 1324. The bus 1324 may include any number of interconnecting buses and bridges depending on the specific application of the processing system/controller 1314 and the overall design constraints. The bus 1324 links together various circuits including one or more processors and/or hardware modules, represented by the processor 1304, the modules 1204, 1206, 1208, and the computer-readable medium 1306. The bus 1324 may also link various other circuits such as timing sources, peripherals, voltage regulators, and power management circuits, which are well known in the art, and therefore, will not be described any further.

The processing system/controller 1314 includes a processor 1304 coupled to a computer-readable medium 1306. The processor 1304 is responsible for general processing, including the execution of software stored on the computer-readable medium 1306. The software, when executed by the processor 1304, causes the processing system/controller 1314 to perform the various functions described supra for any particular apparatus. The computer-readable medium 1306 may also be used for storing data that is manipulated by the processor 1304 when executing software. The processing system/controller further includes at least one of the modules 1204, 1206, 1208. The modules may be software modules running in the processor 1304, resident/stored in the computer readable medium 1306, one or more hardware modules coupled to the processor 1304, or some combination thereof. For example, the module 1204 may be a software module running in the processor 1304 or resident/stored in the computer readable medium 1306, the module 1206 may be a hardware module such as a DAC, and the module 1208 may be a hardware module and/or a software module running in the processor 1304 or resident/stored in the computer readable medium 1306.

In one configuration, the apparatus 1302 reduces noise in headphones due to a change in a current or a voltage in the headphones while determining an impedance of the headphones. The apparatus includes means for generating a digital waveform that reduces noise in the headphones when applied for an impedance determination, means for converting the digital waveform to an analog waveform, means for applying the analog waveform to an input of the headphones while reducing the noise in the headphones due to the application of the analog waveform for the impedance determination, and means for determining the impedance of the headphones based on the applied analog waveform. The first derivative of the analog waveform may be continuous. The analog waveform may be “s” shaped. The means for generating the digital waveform may be configured to generate a ramp digital waveform fᵣ(N). The ramp digital waveform fᵣ(N) may be generated by integrating, with an accumulator, input from a tri-state input block. The ramp digital waveform fᵣ(N) may be generated with an increment/decrement block. The means for generating the digital waveform may be configured to integrate the ramp digital waveform fᵣ(N) to generate the digital waveform. The digital waveform may be generated by integrating, with an accumulator, the ramp digital waveform fᵣ(N). The means for generating the ramp digital waveform fᵣ(N) may be configured to generate a step digital waveform f_{S}(N), and to integrate the step digital waveform f_{S}(N) to generate the ramp digital waveform fᵣ(N). The ramp digital waveform fᵣ(N) may be generated by integrating, with an accumulator, the step digital waveform f_{S}(N). The aforementioned means may be one or more of the aforementioned modules of the apparatus 1202, the processing system/controller 1314 of the apparatus 1202, the modules within the impedance determination apparatus 230, and/or the blocks/modules of the digital waveform generator module 300 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of reducing noise in headphones due to a change in a current or a voltage in the headphones while determining an impedance of the headphones, comprising:
generating a digital waveform that reduces noise in the headphones when applied for an impedance determination;
converting the digital waveform to an analog waveform;
applying the analog waveform to an input of the headphones while reducing the noise in the headphones due to the application of the analog waveform for the impedance determination; and
determining the impedance of the headphones based on the applied analog waveform.

2. The method of claim 1, wherein a first derivative of the analog waveform is continuous.

3. The method of claim 1, wherein the analog waveform is “s” shaped.

4. The method of claim 1, wherein the generating the digital waveform comprises generating a ramp digital waveform fᵣ(N).

5. The method of claim 4, wherein the ramp digital waveform fᵣ(N) is generated by integrating, with an accumulator, input from a tri-state input block.

6. The method of claim 4, wherein the ramp digital waveform fᵣ(N) is generated with an increment/decrement block.

7. The method of claim 4, wherein the ramp digital waveform fᵣ(N) is equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N, T_{R}, and T_{Z} are integers, T_{R}>0, and T_{Z}≧0.

8. The method of claim 4, wherein the generating the digital waveform further comprises integrating the ramp digital waveform fᵣ(N) to generate the digital waveform.

9. The method of claim 8, wherein the digital waveform is generated by integrating, with an accumulator, the ramp digital waveform fᵣ(N).

10. The method of claim 4, wherein the generating the ramp digital waveform fᵣ(N) comprises:
generating a step digital waveform f_{S}(N); and
integrating the step digital waveform f_{S}(N) to generate the ramp digital waveform fᵣ(N).

11. The method of claim 10, wherein the ramp digital waveform fᵣ(N) is generated by integrating, with an accumulator, the step digital waveform f_{S}(N).

12. The method of claim 10, wherein the step digital waveform f_{S}(N) is equal to A for 0≦N≦T_{R}, 0 for T_{R}<N<T_{R}+T_{Z}, and −A for T_{R}+T_{Z}≦N≦2T_{R}+T_{Z}, where N, T_{R}, and T_{Z} are integers, T_{R}>0, and T_{Z}≧0.

13. The method of claim 1, wherein the digital waveform f(N) is equal to AN²/2 for 0≦N≦T_{R}, AT_{R}N−AT_{R}²/2 for T_{R}<N<T_{R}±T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}≧0.

14. An apparatus for reducing noise in headphones due to a change in a current or a voltage in the headphones while determining an impedance of the headphones, comprising:
means for generating a digital waveform that reduces noise in the headphones when applied for an impedance determination;
means for converting the digital waveform to an analog waveform;
means for applying the analog waveform to an input of the headphones while reducing the noise in the headphones due to the application of the analog waveform for the impedance determination; and
means for determining the impedance of the headphones based on the applied analog waveform.

15. The apparatus of claim 14, wherein a first derivative of the analog waveform is continuous.

16. The apparatus of claim 14, wherein the analog waveform is “s” shaped.

17. The apparatus of claim 14, wherein the means for generating the digital waveform is configured to generate a ramp digital waveform fᵣ(N).

18. The apparatus of claim 17, wherein the ramp digital waveform fᵣ(N) is generated by integrating, with an accumulator, input from a tri-state input block.

19. The apparatus of claim 17, wherein the ramp digital waveform fᵣ(N) is generated with an increment/decrement block.

20. The apparatus of claim 17, wherein the ramp digital waveform f^{r}(N) is equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N, T_{R}, and T_{Z} are integers, T_{R}>0, and T_{Z}≧0.

21. The apparatus of claim 17, wherein the means for generating the digital waveform is configured to integrate the ramp digital waveform fᵣ(N) to generate the digital waveform.

22. The apparatus of claim 21, wherein the digital waveform is generated by integrating, with an accumulator, the ramp digital waveform fᵣ(N).

23. The apparatus of claim 17, wherein the means for generating the ramp digital waveform fᵣ(N) is configured to:
generate a step digital waveform f_{S}(N); and
integrate the step digital waveform f_{S}(N) to generate the ramp digital waveform fᵣ(N)

24. The apparatus of claim 23, wherein the ramp digital waveform fᵣ(N) is generated by integrating, with an accumulator, the step digital waveform f_{S}(N).

25. The apparatus of claim 23, wherein the step digital waveform f_{S}(N) is equal to A for 0≦N≦T_{R}, 0 for T_{R}<N<T_{R}+T_{Z}, and −A for T_{R}+T_{Z}≦N≦2T_{R}+T_{Z}, where N, T_{R}, and T_{Z} are integers, T_{R}>0, and T_{Z}≧0.

26. The apparatus of claim 14, wherein the digital waveform f(N) is equal to AN²/2 for 0≦N≦T_{R}, AT_{R}N−AT_{R}²/2 for T_{R}<N<T_{R}+T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}≧0.

27. An apparatus for reducing noise in headphones due to a change in a current or a voltage in the headphones while determining an impedance of the headphones, comprising:
a digital waveform generator module configured to generate a digital waveform that reduces noise in the headphones when applied for an impedance determination;
a digital to analog converter module configured to convert the digital waveform to an analog waveform; and
an impedance determination module configured to apply the analog waveform to an input of the headphones while reducing the noise in the headphones due to the application of the analog waveform for the impedance determination, and to determine the impedance of the headphones based on the applied analog waveform.

28. The apparatus of claim 27, wherein a first derivative of the analog waveform is continuous.

29. The apparatus of claim 27, wherein the analog waveform is “s” shaped.

30. The apparatus of claim 27, wherein the digital waveform generator module is configured to generate the digital waveform by generating a ramp digital waveform fᵣ(N).

31. The apparatus of claim 30, wherein the ramp digital waveform fᵣ(N) is generated by integrating, with an accumulator, input from a tri-state input block.

32. The apparatus of claim 30, wherein the ramp digital waveform fᵣ(N) is generated with an increment/decrement block.

33. The apparatus of claim 30, wherein the ramp digital waveform fᵣ(N) is equal to AN for 0≦N≦T_{R}, AT_{R} for T_{R}<N<T_{R}+T_{Z}, and −AN+A(2T_{R}+T_{Z}) for T_{R}+T_{Z}≦N≦2T_{R}+T_{Z}, where N, T_{R}, and T_{Z} are integers, T_{R}>0, and T_{Z}≧0.

34. The apparatus of claim 30, wherein the digital waveform generator module is configured to generate the digital waveform by integrating the ramp digital waveform fᵣ(N) to generate the digital waveform.

35. The apparatus of claim 34, wherein the digital waveform is generated by integrating, with an accumulator, the ramp digital waveform fᵣ(N).

36. The apparatus of claim 30, wherein the digital waveform generator module is configured to generate the ramp digital waveform fᵣ(N) by:
generating a step digital waveform f_{S}(N); and
integrating the step digital waveform f_{S}(N) to generate the ramp digital waveform fᵣ(N).

37. The apparatus of claim 36, wherein the ramp digital waveform fᵣ(N) is generated by integrating, with an accumulator, the step digital waveform f_{S}(N).

38. The apparatus of claim 36, wherein the step digital waveform f_{S}(N) is equal to A for 0≦N≦T_{R}, 0 for T_{R}<N<T_{R}+T_{Z}, and −A for T_{R}+T_{Z}≦N≦2T_{R}+T_{Z}, where N, T_{R}, and T_{Z} are integers, T_{R}>0, and T_{Z}≧0.

39. The apparatus of claim 27, wherein the digital waveform f(N) is equal to AN²/2 for 0≦N≦T_{R}, AT_{R}N−AT_{R}²/2 for T_{R}<N<T_{R}+T_{Z}, and −AN²/2+AN(2T_{R}+T_{Z})−A(T_{R}²+T_{R}T_{Z}+T_{Z}²/2) for T_{R}+T_{Z}≦N≦2T_{R}+T_{Z}, where N, T_{R}, and T_{Z} are integers, T_{R}>0, and T_{Z}≧0.
